(19) United States
(12) Patent Application Publication
(10) Pub. No.: US 2025/0209401 A1
(43) Pub. Date: Jun. 26, 2025

(54) DATABRIDGE WITH DATAFLOW STUDIO

(71) Applicant: Intergraph Corporation, Madison, AL (US)

(72) Inventor: Julio P. Roque, Coconut Grove, FL (US)

(21) Appl. No.: 19/076,763

(22) Filed: Mar. 11, 2025

Related U.S. Application Data
(63) Continuation of application No. PCT/US2024/054644, filed on Nov. 6, 2024.
(60) Provisional application No. 63/547,441, filed on Nov. 6, 2023.

(51) Int. Cl. G06Q 10/0631; G06F 3/0486

(52) U.S. Cl. CPC G06Q 10/06316; G06F 3/0486

(57) ABSTRACT

A system for integrating an enterprise asset management (EAM) system with enterprise applications implements a dataflow studio and an endpoint catalog. The dataflow studio provides a no-code graphical user interface for building and configuring customized business-specific data and process flows between the EAM system and enterprise applications, wherein the dataflow studio integrates with the EAM system via an API for sending records to the EAM system and for receiving records from the EAM system. The endpoint catalog provides a centralized registry of enterprise applications that are available to the dataflow studio as endpoints for creating and managing application connections for data integrations between the EAM system and the enterprise applications. A 360 transaction view component may be included to integrate data events from the dataflow studio into a user-comprehensible flow to provide visibility into data and process flows both within the EAM system and within the dataflow studio.

### CROSS-REFERENCE TO RELATED APPLICATION(S)

This patent application is a continuation of International Patent Application No. PCT/US2024/054644 entitled DATABRIDGE WITH DATAFLOW STUDIO filed Nov. 6, 2024, which claims the benefit of U.S. Provisional Patent Application No. 63/547,441 entitled DATABRIDGE WITH DATAFLOW STUDIO filed Nov. 6, 2023, each of which is hereby incorporated herein by reference in its entirety.

### STATEMENT REGARDING PRIOR DISCLOSURES BY THE INVENTOR OR A JOINT INVENTOR UNDER 37 C.F.R. 1.77 (B)(6)

A high-level introduction to Databridge Pro was available by at least Oct. 30, 2023 from https://docs.hexagonali.com/r/en-US/EAM-What-s-New/12.1/1380538, as follows:

EAM Databridge Pro is the next generation of EAM Databridge, delivering advanced capabilities for data integration and movement between EAM and external applications. Databridge Pro utilizes components both inside and outside of the EAM application and provides the ability to build and manage customized data pipelines streamline endpoint connections and usage; simplifying the troubleshooting process by offering insights into the complete EAM message journey.

Databridge Pro is built upon three components:
Dataflow Studio—A no-code, graphical interface to build and configure customized data flows between EAM and enterprise applications.
Endpoint Catalog—A centralized registry to create and manage application connections for data integrations, such as REST APIs or SFTP file storage.
360 Transaction View—An insight to what occurs to a Databridge document message outside of the EAM application. This view integrates data events from Dataflow Studio into a comprehensible flow, extending visibility and accessibility not available before.

Pursuant to the guidance of 78 Fed. Reg. 11076 (Feb. 14, 2013), Applicant is identifying this disclosure in the specification in lieu of filing a declaration under 37 C.F.R. 1.130(a). Applicant believes that such disclosure is subject to the exceptions of 35 U.S.C. 102(b)(1)(A) or 35 U.S.C. 102(b)(2)(a) as having been made or having originated from one or more members of the inventive entity of the application under examination.

### FIELD OF THE INVENTION

The invention generally relates to a middleware messaging system specifically for Enterprise Asset Management (EAM) systems, in particular, where EAM is integrated into other applications to interchange assets, work orders, and related EAM data.

### BACKGROUND OF THE INVENTION

Databridge Pro is a Hexagon Enterprise Asset Management (EAM) system component that provides messaging and messaging-related processing for assets, work orders, and other EAM data.

### SUMMARY OF VARIOUS EMBODIMENTS

In accordance with one embodiment of the invention, a system, computer program product, and method include implementation of a dataflow studio comprising a no-code graphical user interface for building and configuring customized business-specific data and process flows between the EAM system and enterprise applications, wherein the dataflow studio integrates with the EAM system via an API including a ToEAM queue for sending records to the EAM system and a FromEAM queue for receiving records from the EAM system; and an endpoint catalog comprising a centralized registry of enterprise applications that are available to the dataflow studio as endpoints for creating and managing application connections for data integrations between the EAM system and the enterprise applications.

In various alternative embodiments, the enterprise applications may include enterprise applications internal to the EAM system, enterprise applications external to the EAM system, and/or IoT/sensor devices. The ToEAM queue and the FromEAM queue may be managed AWS SQS BOD queues. The dataflow studio may be configured to allow a user to build and configure a flow by linking processors that receive and process data from the EAM system for use by an enterprise application endpoint and/or receive and process data from the enterprise application endpoint for use by the EAM system, in which case the dataflow studio may include a drag-and-drop interface to build and configure the flow. The dataflow studio may be configured to periodically query the FromEAM queue for records from the EAM system. The API further may further include a RESTful API. The dataflow studio may include an integration component, a transformation component, and an analysis component. Embodiments also may include a 360 transaction view component configured to integrate data events from the dataflow studio into a user-comprehensible flow to provide visibility into data and process flows both within the EAM system and within the dataflow studio, in which case the 360 transaction view component may allow a user to troubleshoot a message transaction utilizing an end-to-end view of messages between the EAM system and the dataflow studio.

In various embodiments, creation of a process flow between the dataflow studio and the endpoint catalog may involve querying the EAM system by the dataflow studio for tenant specific endpoint connections in the endpoint catalog; causing display of a dialog box listing the tenant specific endpoint connections on a display device of a user computer; in response to receiving a user input of a selected tenant specific endpoint connection, mapping, by the dataflow studio, the selected tenant specific endpoint connection to a corresponding processor type, configuring the selected tenant specific endpoint connection using metadata values from the EAM system, and writing a UUID of the processor to the EAM system as endpoint metadata for reference; and updating endpoint metadata for the endpoint in the EAM system including querying the dataflow studio by the EAM system for a reference to the processor and updating the endpoint metadata based on the reference to the processor.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic diagram showing the Databridge Pro architecture.

FIG. 2 is a schematic diagram showing DataFlow Studio components and the Cloud deployment environment in which it runs.

FIG. 3 is a schematic diagram showing DataFlow Studio integration with EAM through IOBox (i.e., using existing IOBox database tables).

FIG. 4 shows an example process flow defined via the NiFi user interface in which a record is pulled from the outbox for processing.

FIG. 5 is a schematic diagram showing EAM Endpoint Catalog.

FIG. 6 is a schematic diagram showing an Inbound Message service.

FIG. 7 is a schematic diagram showing 360 View of provenance data from EAM.

FIG. 8 is a schematic diagram showing a DataFlow Studio user interface screen produced using NiFi through which a process flow can be created by dragging/dropping and interconnecting various processors.

FIG. 9 is a schematic diagram showing screens for adding and configuring processors.

FIG. 10 is a schematic diagram showing a DataFlow Studio user interface screen for creating EAM IOBox processors.

FIG. 11 is a schematic diagram showing creation of a BOD connection processor.

FIG. 12 is a schematic diagram showing SAP to EAM integration via direct connection.

FIG. 13 is a schematic diagram showing EAM to SAP integration flow via reverse proxy.

FIG. 14 is a schematic diagram showing SAP to EAM integration flow via local connector.

FIG. 15 is a schematic diagram showing the integration of EAM to datalakes flow via a dedication processor, allowing EAM a decouple integration strategy to all the leading datalakes and enabling customers to move data from EAM to Azure datalake, AWS datalake, Snowflake datalake, and others as required.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Embodiments provide an enhanced messaging middleware component. Certain embodiments are designed specifically for the Hexagon EAM Databridge Pro and are described in that context below, although alternative embodiments encompassing some or all of the described functionality can be used more generally in other messaging systems and environments.

For purposes of the following discussion and claims, the term “periodically” with regard to an action (such as in periodically querying a queue) includes taking the action from time to time and not necessarily on a true periodic basis.

Databridge Pro is the next generation of Databridge, a critical component of Hexagon EAM. It delivers advanced capabilities for data integration and data movement between EAM and external applications. Databridge Pro utilizes components both inside and outside of the EAM application and provides the ability to build and manage customized data pipelines streamline endpoint connections and usage, simplifying the troubleshooting process by offering insights into the complete EAM message journey.

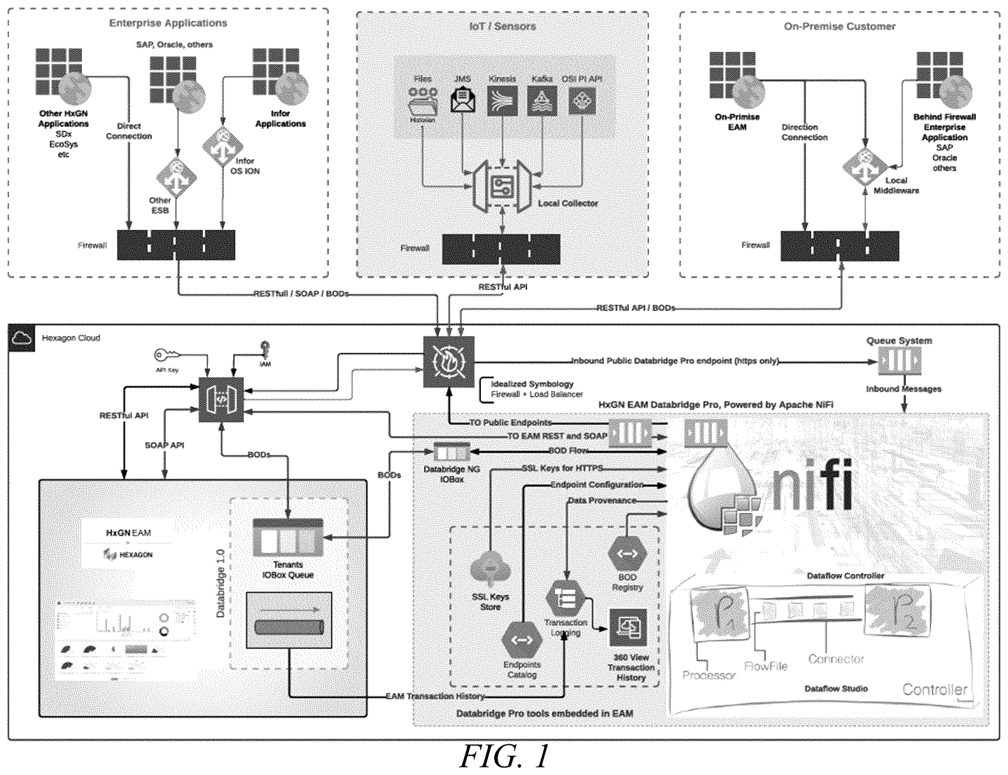

FIG. 1 is a schematic diagram showing the Databridge Pro architecture. As shown, Databridge Pro is implemented using the Apache NiFi open-source platform with extensions that allow messaging for such things as, without limitation, internal and external enterprise applications (e.g., SAP, Oracle, EAM, etc.) and IoT/sensor devices. Databridge Pro is built upon three main components:
DataFlow Studio—A no-code, graphical interface to build and configure customized business-specific data/process flows between EAM and enterprise applications. DataFlow Studio comprises standalone integration, transformation, and analysis components connected to the Endpoint Catalog.
Endpoint Catalog—A centralized registry to create and manage application connections for data integrations, such as REST APIs and SFTP file storage. Among other things, Endpoint Catalog manages external connections to use as final message destinations, which can be utilized when building data/process flows in DataFlow Studio. The Endpoint Catalog resides in EAM and is linked to DataFlow Studio.
360 Transaction View—An insight to what occurs to a Databridge Pro document message outside of the EAM application. This view integrates data events from DataFlow Studio into a comprehensible flow, extending visibility and accessibility. For example, 360 Transaction View can be used to troubleshoot what happened during a message transaction utilizing an end-to-end view of messages from EAM to DataFlow Studio. The 360 Transaction View resides in EAM and is included with Databridge Messages.

Among other things, the Apache NiFi system is used to implement a DataFlow Controller, which automates and manages secure data communication defined dataflows in DataFlow Studio. The DataFlow Controller is connected with EAM via both Business Object Document (BOD) and RESTful APIs. In essence, DataFlow Studio and DataFlow Controller are used by personas such as programmers and services who may not have knowledge or access to the EAM system, whereas Endpoint Catalog and 360 Transaction View are used by personas such as EAM users and system operators who may not have knowledge or access to the NiFi system.

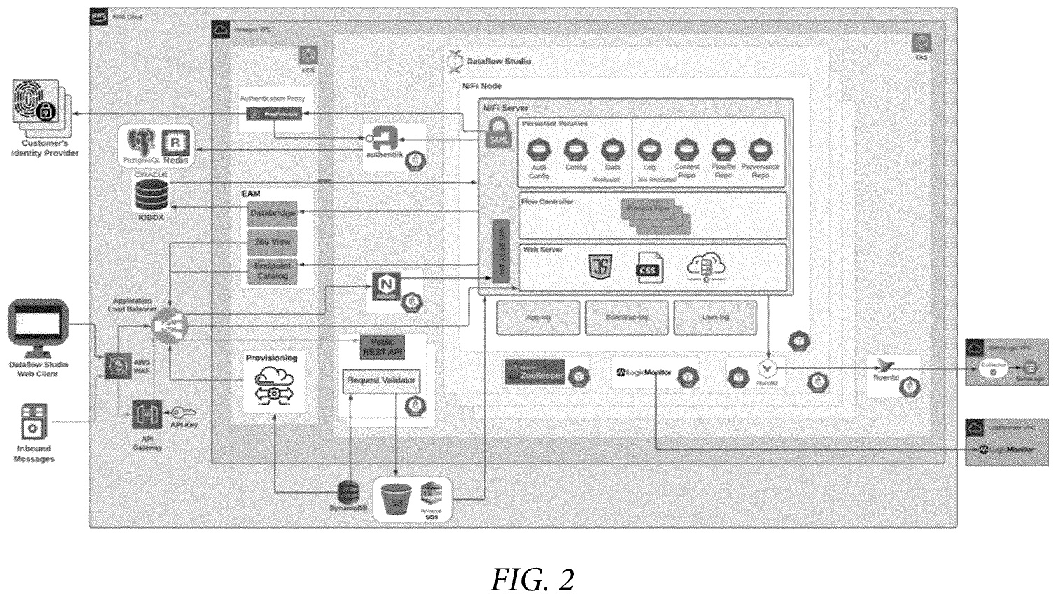

FIG. 2 is a schematic diagram showing DataFlow Studio components and the Cloud deployment environment in which it runs. Dataflow Studio is based on Apache NiFi and generally has the following design goals:
AWS Cognito will handle authentication. Customers with their own IdP will have their tenants mapped to delegate authentication to their IdP. Customers without an IdP will have their tenants mapped to store credentials in Authentik.
Multi-tenant cloud deployment and provisioning across multiple AWS global regions.
Deployment is Highly Available, deployed across multiple Availability Zones.
Zero-Down-time is achieved utilizing a Blue-Green strategy.
Brand the UI to match EAM styles.
Integration with EAM through AWS SQS-managed queues.
Support for 360 View of provenance data from EAM.
Ability to add Processors based on EAM Endpoint Catalog.
Provide an Inbound Message for customers to push messages into a process flow.

Architecture highlights include:
Deployed across multiple Kubernetes clusters, at least two AWS Availability Zones, within multiple global AWS regions, where each DataFlow Studio node runs within a Kubernetes Pod.
Node groups are used to allow individual scaling of components. Node groups exist for NiFi Server; Authentik—local authentication; Nginx—proxy that allows EAM to use api-keys for authentication, and uses a certificate to communicate with NiFi; Fluentd—consolidates logging requests from Fluentbit and sends them to the Sumologic collector; and Inbound Message Public RESTful api.
The “Data” persistent volume contains two H2 embedded databases, specifically nifi-flow-audit.h2.db is used to keep track of all configuration changes made within the Databridge Studio UI and nifi-user-keys.h2.db is only used when Dataflow Studio has been secured and contains information about who has logged in.
As a data retention policy, the Content repository (flow files and data) will be saved until the repository reaches 85% full. At that point the content will be archived, and the archive will be deleted after 3 days.
As a data retention policy, the Provenance data will be maintained for 10 days, at which point it will be deleted.
All requests to the public RESTful api are validated by tenant in the provisioning DynamoDB.
Crowdstrike is deployed on every Kubernetes node.
Rapid 7 client is installed to enable security scans.

NiFi was developed for the National Security Agency (NSA) and was open sourced in 2014. The following is some NiFi terminology:
FlowFile—Represents each object moving through the system, analogous to a BOD.
Processor—Performs work related to a FlowFile.
Connection—Acts as a queue and provides linkage between Processors.
Process Flow—Set of connected Processors.
Process Group—Logical organization of Process Flows. Key for tenant isolation.
Provenance Data—Record of Process Flow execution.

Some NiFi challenges for the implementation of DataFlow Studio include:
NiFi does not natively support multi-tenant. It supports multi-user with access to all Process Groups across the system. Therefore, NiFi was extended to support the concept of a tenant.
NiFi is designed to run the entire system for all users on a single NiFi cluster. There will be a finite limit to the number of tenants and process flows that can be supported on a single instance.
NiFi data is comingled across tenants in the Persistent Volumes.
Persistent Volumes are stored on the filesystem not a database. The access policies should restrict access to the filesystem. Need full verification to identify edge cases.
In addition to SSO, NiFi requires all users to be contained in the users.xml and authorizations.xml configuration files.
Users have access to api from the browser and can reverse engineer api calls. The access policies should restrict using the api. Need full verification to identify edge cases.
The UUID of the process flow changes any time the flow file is modified. The linkage through the entire flow depends on parent/child references.
Deploying NiFi nodes across availability zones requires custom deployment.
All process flows run on the Primary node. A Processor configuration change must be made to run on other nodes. This can limit horizontal scalability.

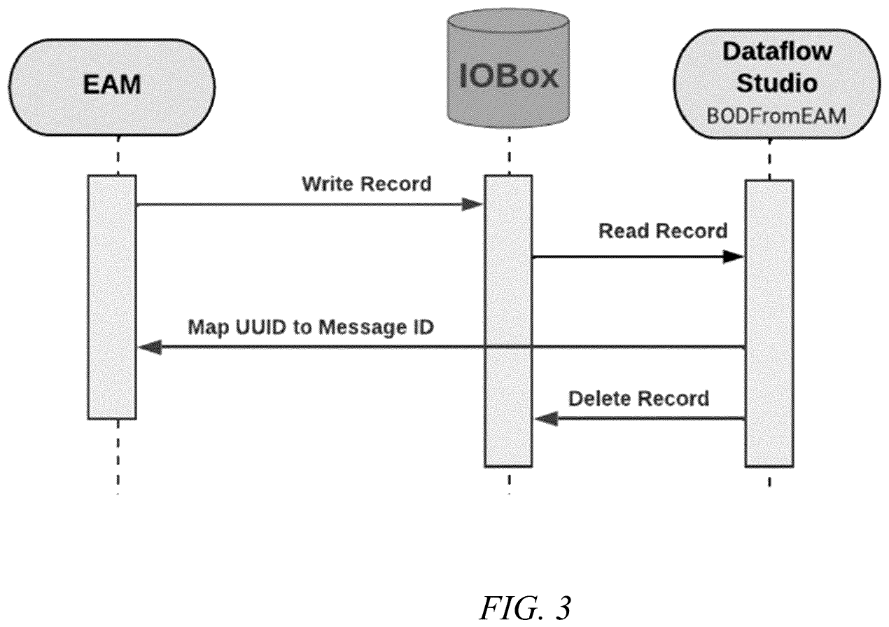

As mentioned above, DataFlow Studio can be integrated with EAM such as through managed AWS SQS BOD queues. In this exemplary embodiment, the outbound will be a “pull” integration where a Dataflow Studio Processor periodically queries the queue for new records to process, although alternative embodiments could allow for “push” integration where new records are pushed to a Dataflow Studio Processor. Inbound will write to the SQS queue. More specifically, this exemplary embodiment creates two custom EAM BODs Processors in Dataflow Studio, referred to herein as BODFromEAM and BODToEAM. BODFromEAM will read a record from the Outbox AWS SQS queue, call an EAM api to map the UUID to the message id, and delete the record from the Outbox queue. BODToEAM will write a new record to the Inbox queue and write the last process event UUID to the table, as depicted schematically in FIG. 3. In this example, the following attributes are used in IOBox headers table:
MessageId—Flow file UUID
ToLogicalId—lid://hxgn.eam.iobox (this value is fixed for all request)
FromLogicalId—lid://hxgn.dfstudio.iobox (this value is fixed for all request)
VariationId—current timestamp in milliseconds
CreateDateTime—current date and time
TenantId—tenant ID
BODType—Selected Bod Type

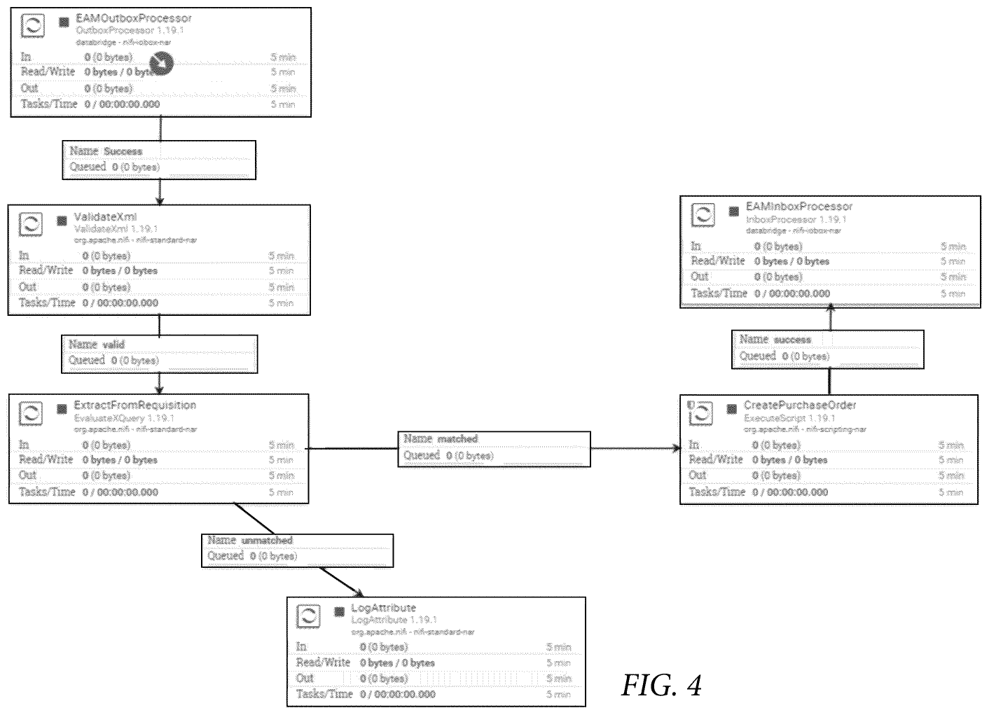

FIG. 4 shows an example process flow defined via the NiFi user interface in which a record is pulled from the outbox for processing. In this example, EAMOutboxProcessor may be an endpoint created using the EAM Endpoint Catalog as discussed below.

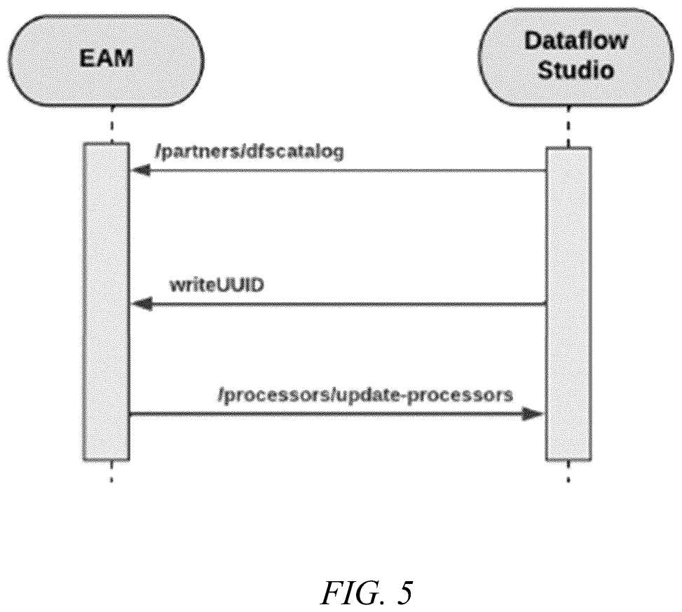

As mentioned above, exemplary embodiments allow processors to be added based on EAM Endpoint Catalog. The Endpoint Catalog in EAM allows the ability to define a third-party endpoint as a final destination for a message that originates in AWS SQS queues. The endpoint type and metadata will be defined in EAM. These endpoints will be utilized in Dataflow Studio by creating a process flow that first contains the EAM IOBox Processor to retrieve records to process. At this point, the user could do transformations on the data, eventually sending the message to the final endpoint destination. To enable this in NiFi, the user can create a new creation icon similar to the Create Process icon. When the icon is selected, it will query EAM for tenant specific Endpoint Connections and display a dialog box with the list, as depicted schematically in FIG. 5. Once an Endpoint is selected, it will map to an appropriate Processor type, create the processor on the canvas, and configure it using metadata values from EAM. The UUID of the NiFi processor will be written to the EAM Endpoint metadata for reference, as depicted schematically in FIG. 5. When a metadata value is changed for an Endpoint in EAM, that value will have to be updated in NiFi. EAM will use the NiFi RESTful api to get a reference to the Processor and update the value, as depicted schematically in FIG. 5.

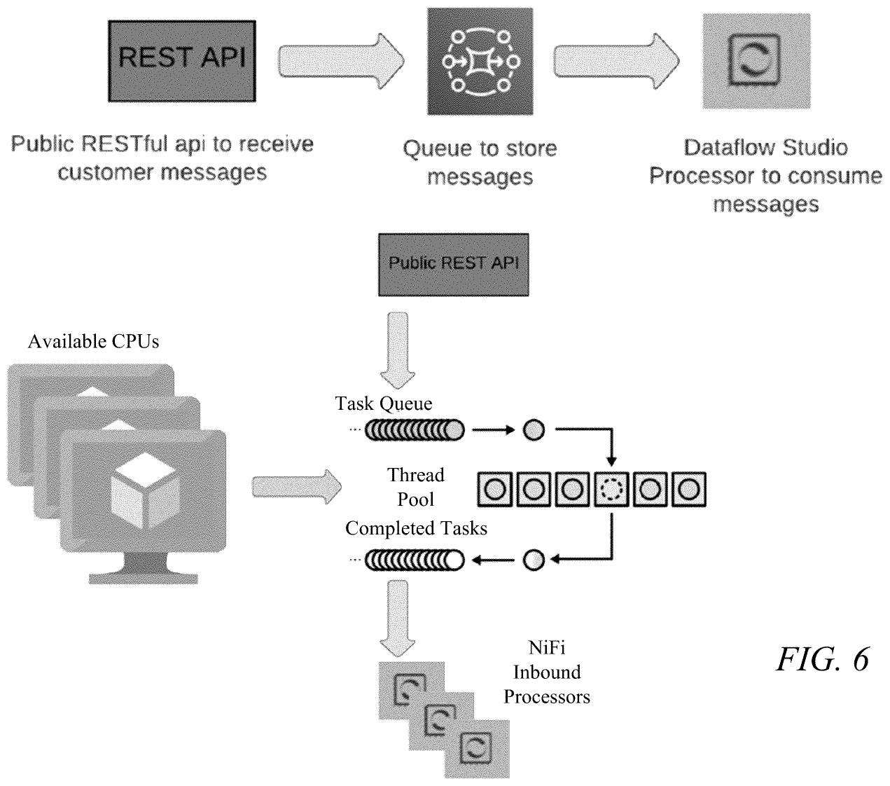

As mentioned above, exemplary embodiments can provide an Inbound Message service for customers to push messages into a process flow. As depicted schematically in FIG. 6 (top), an exemplary embodiment includes a public RESTful api to receive customer messages, a queue to store messages, and a DataFlow Studio processor to consume messages. In an exemplary embodiment, all requests are validated against the Provisioning Service to ensure tenants are provisioned and entitled, and messages are persisted to survive system recovery and provide retries and failure isolation. Some additional design goals include high throughput of messages, limiting the effect of one tenant on others, reducing “noisy neighbor” problem, tooling and monitoring of the Queue for Cloud Ops, providing Support with the ability to clear messages from the queue for a particular client, minimizing CloudOps overhead, using dynamically generated dedicated queues for each tenant, and providing an attribute in the Processor to route messages. One exemplary embodiment uses AWS SQS for the Queuing mechanism, uses Extended Client Library to handle large messages, uses m5n.xlarge machines and configures autoscaling when CPU utilization exceeds 65%, isolates tenants with large message processing needs to avoid thread pool issues, provides documentation and optionally also system limits on Processor settings for Execution, Run Schedule and Concurrency, allows execution to be set to either Primary or All Nodes but documents the resource usage, restricts run Schedule to be greater than 0 (a setting of 0 dedicates a thread that can't be shared), and limits concurrency to one per tenant (e.g., it uses a thread for each count, and a total count exceeding 48 for all tenants consumes all threads). It should be noted that how a user configures the settings of a processor can impact how resources are utilized on the NiFi server. In particular, the “Run Schedule” can consume processor threads and cause delays in processing across the system. Therefore, as depicted schematically in FIG. 6 (bottom), the number of available CPUs determines the max size of the thread pool. Each time a processor reads the queue, it consumes a thread regardless of whether there was a message in the queue to read. The Processor “run schedule” is set by the customer, and excessive reads can quickly overwhelm the thread pool.

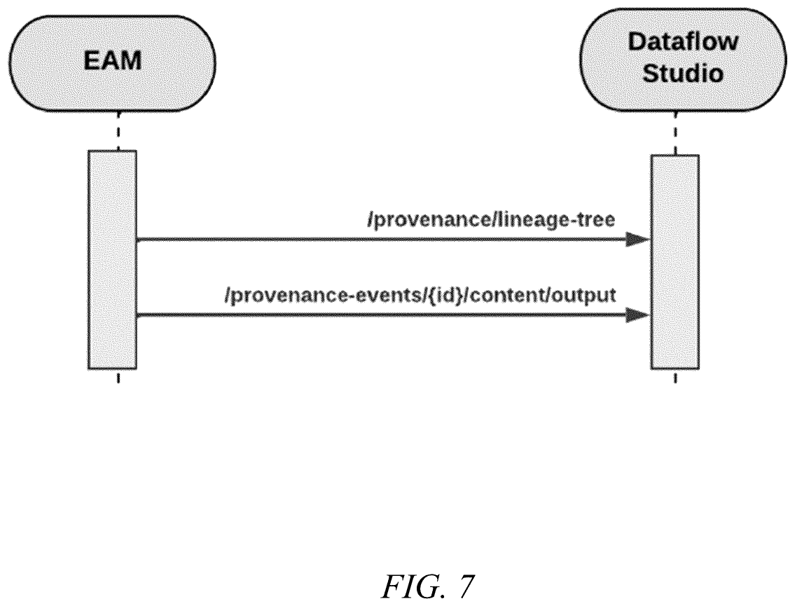

As mentioned above, exemplary embodiments can provide support for 360 View of provenance data from EAM. From EAM, a user can select an event and view the entire process flow both within EAM and continuing into Dataflow Studio. As depicted schematically in FIG. 7, the NiFi RESTful api is extended to query provenance data by the UUID of the first event in the process flow and traverse the linkage for all child provenance events. EAM will retrieve the UUID of the first NiFi event from the BOD Outbox queue and use it to call the NiFi RESTful api to query provenance data.

EAM will display the result as a seamless process flow from end to end.

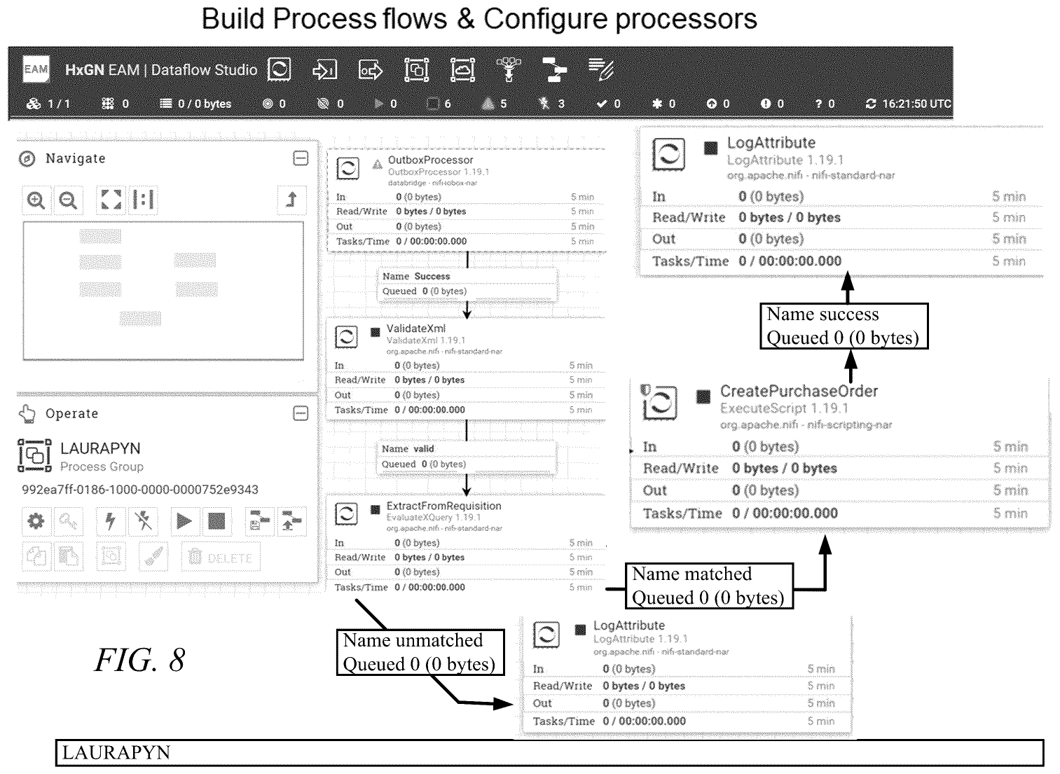

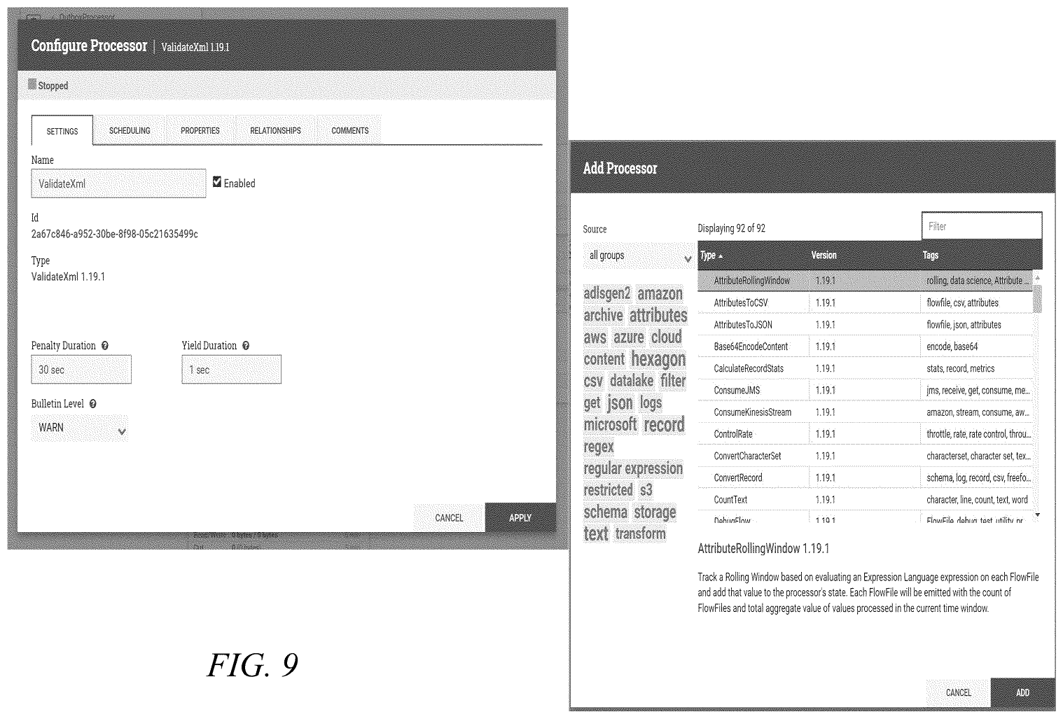

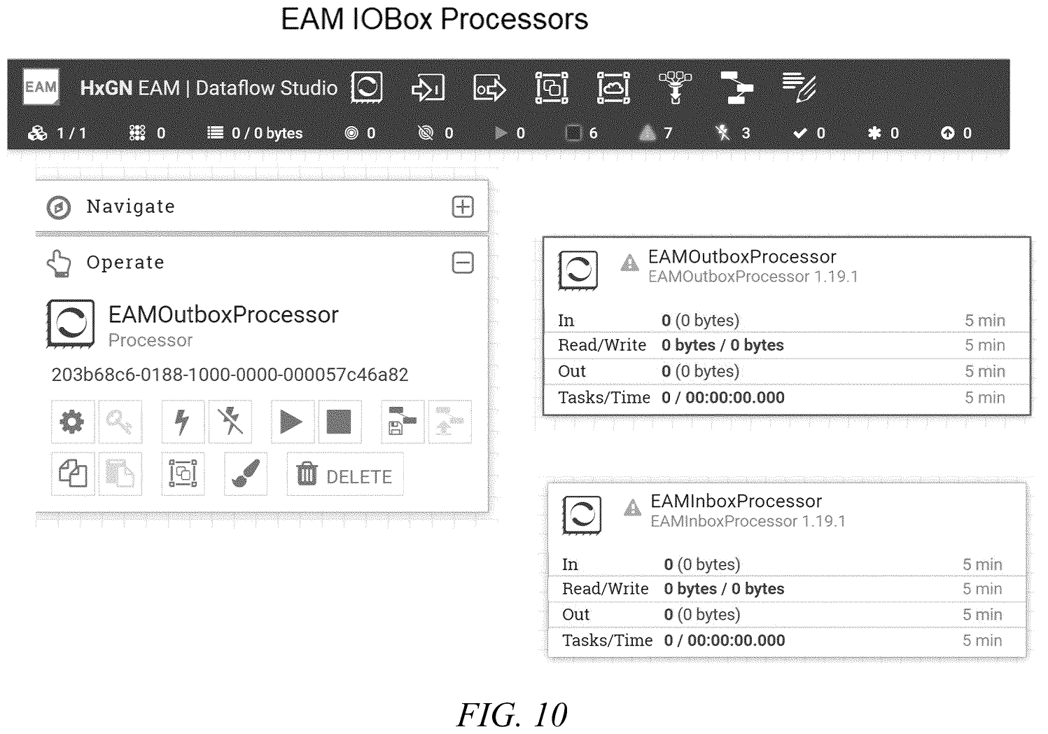

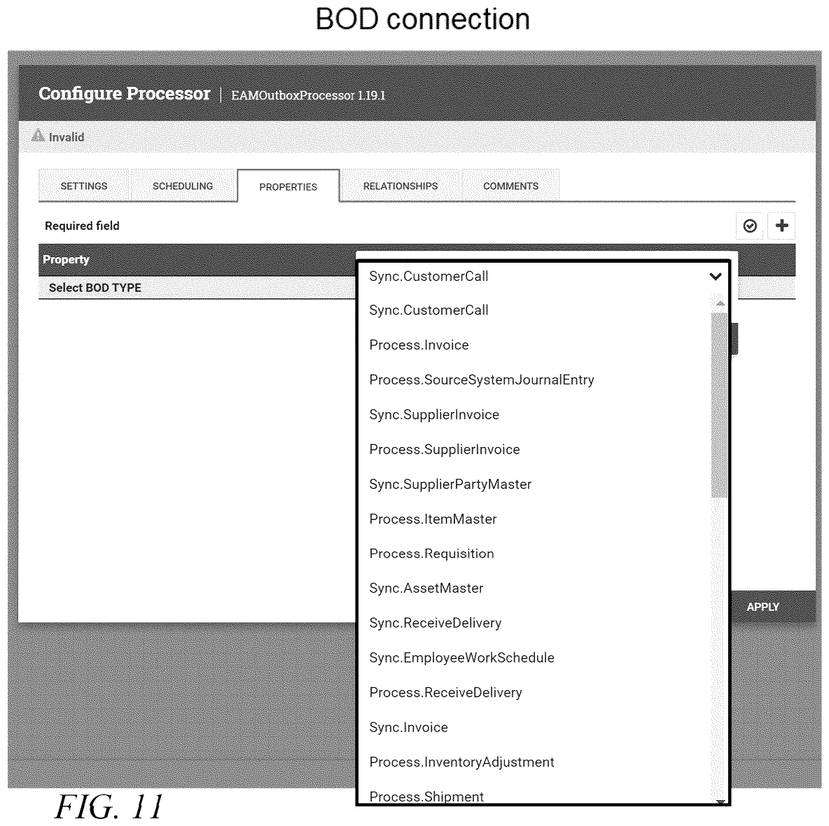

FIG. 8 is a schematic diagram showing a DataFlow Studio user interface screen produced using NiFi through which a process flow can be created by dragging/dropping and interconnecting various processors. A processor such as the OutboxProcessor can be created using the EAM Endpoint Configuration tool. As depicted schematically in FIG. 9, processors can be added and configured. FIG. 10 is a schematic diagram showing a DataFlow Studio user interface screen for creating EAM BOD processors. FIG. 11 is a schematic diagram showing creation of a BOD connection processor.

Certain embodiments include integration of EAM with SAP. In an exemplary embodiment, SAP provides oData REST APIs as integration strategy, Databridge will send messages to SAP through via this integration contract, EAM/Databridge provides REST APIs, and SAP will send messages to EAM/Databridge through these APIs. Call inbound and outbound integrations with SAP are mapped and processed in Databridge, e.g., in an event driven real-time manner that can implemented in a push or pull manner. Importantly, this integration can be accomplished with no Hexagon software on the SAP side, but rather only native SAP programs on the SAP side (although location integration is also possible, if required).

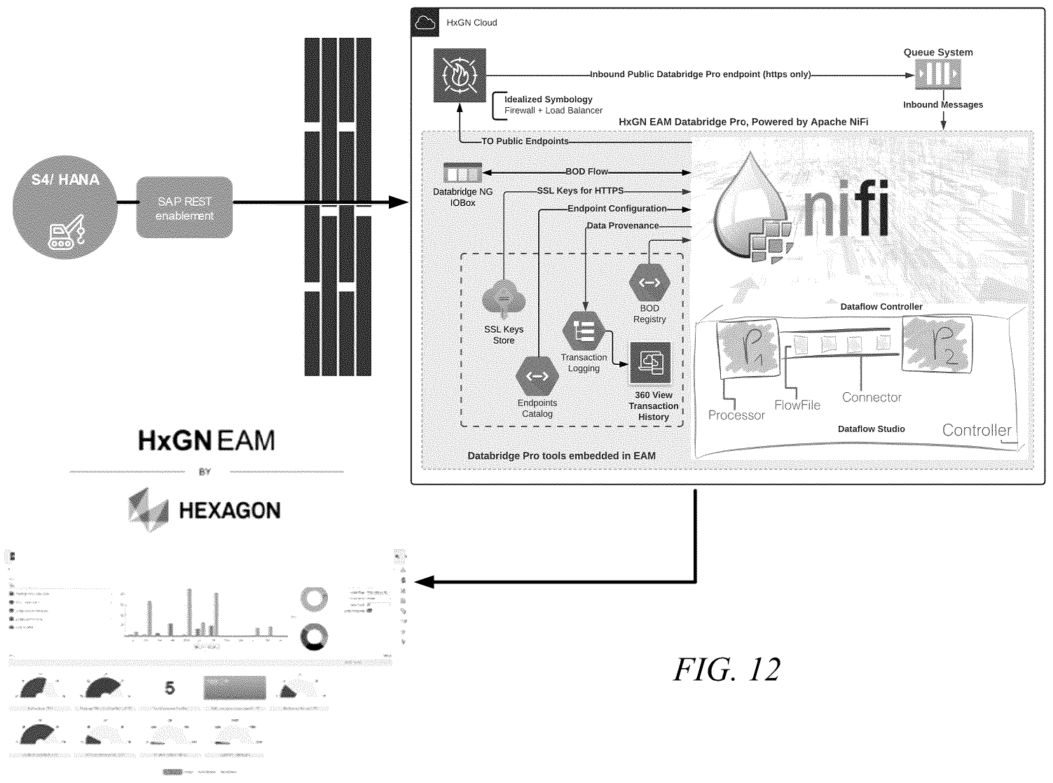

FIG. 12 is a schematic diagram showing SAP to EAM integration via direct connection. This exemplary embodiment utilizes generic REST client enablement with SAP NetWeaver Gateway and security gateway (SEGW). The SAP Program pushes the messages to Databridge Pro directly.

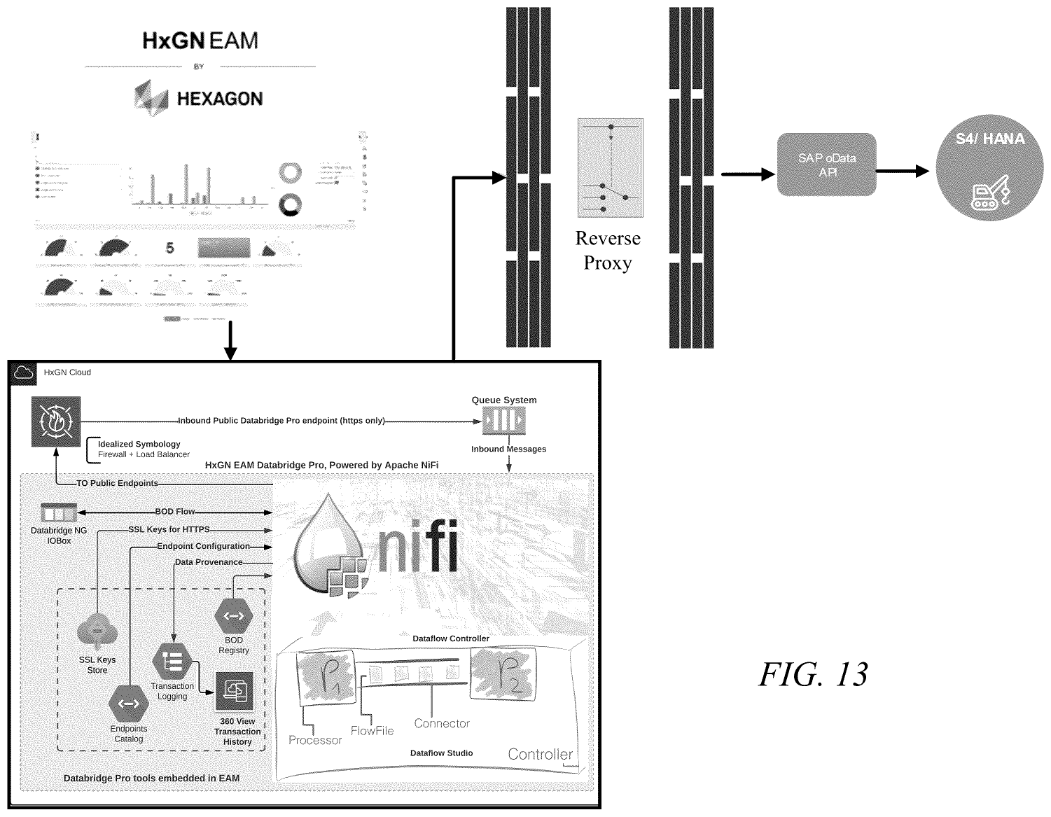

FIG. 13 is a schematic diagram showing EAM to SAP integration flow via reverse proxy. In this exemplary embodiment, SAP provides oData APIs or SAP PO REST APIs that are registered in Gateway and optional Reverse Proxy in DMZ. The Dataflow Studio Pushes the messages from EAM on event.

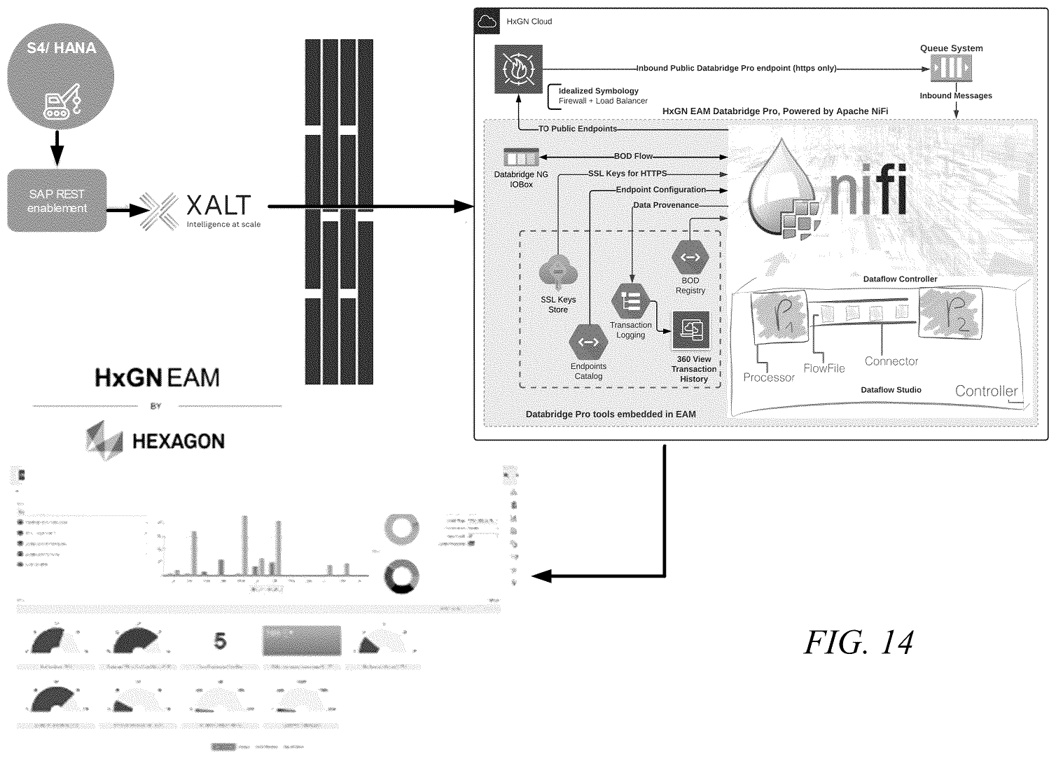

FIG. 14 is a schematic diagram showing SAP to EAM integration flow via local connector. This exemplary embodiment utilizes generic REST client enablement with SAP NetWeaver Gateway and security gateway (SEGW). The SAP Program pushes and requests messages from Databridge Pro via locally installed Databridge Pro Cloud Connector (DCC).

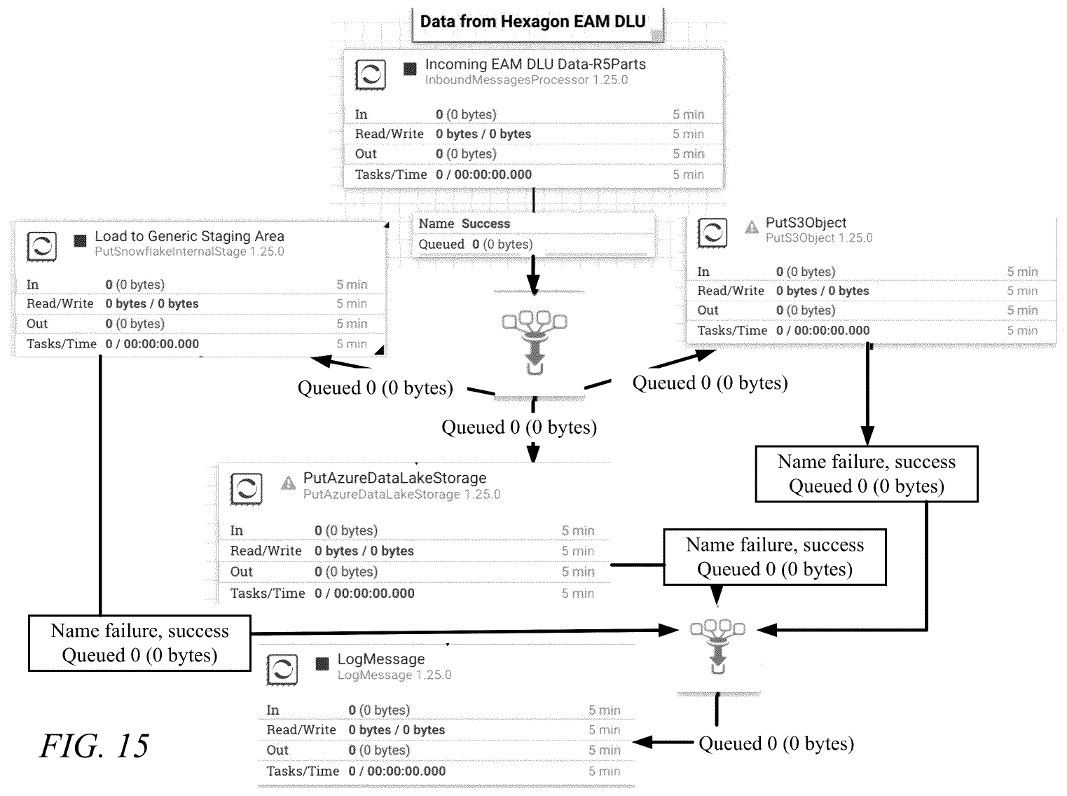

FIG. 15 is a schematic diagram showing the integration of EAM to datalakes flow via a dedication processor, allowing EAM a decouple integration strategy to all the leading datalakes and enabling customers to move data from EAM to Azure datalake, AWS datalake, Snowflake datalake, and others as required.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A system for integrating an enterprise asset management (EAM) system with enterprise applications, the system comprising:
at least one processor; and
at least one memory comprising instructions which, when run on the at least one processor, implements computer processes comprising:
a dataflow studio comprising a no-code graphical user interface for building and configuring customized business-specific data and process flows between the EAM system and enterprise applications, wherein the dataflow studio integrates with the EAM system via an API including a ToEAM queue for sending records to the EAM system and a FromEAM queue for receiving records from the EAM system; and
an endpoint catalog comprising a centralized registry of enterprise applications that are available to the dataflow studio as endpoints for creating and managing application connections for data integrations between the EAM system and the enterprise applications.

2. The system of claim 1, wherein creation of a process flow between the dataflow studio and the endpoint catalog comprises:
querying the EAM system by the dataflow studio for tenant specific endpoint connections in the endpoint catalog;
causing display of a dialog box listing the tenant specific endpoint connections on a display device of a user computer;
in response to receiving a user input of a selected tenant specific endpoint connection, mapping, by the dataflow studio, the selected tenant specific endpoint connection to a corresponding processor type, configuring the selected tenant specific endpoint connection using metadata values from the EAM system, and writing a UUID of the processor to the EAM system as endpoint metadata for reference; and
updating endpoint metadata for the endpoint in the EAM system including querying the dataflow studio by the EAM system for a reference to the processor and updating the endpoint metadata based on the reference to the processor.

3. The system of claim 1, wherein the enterprise applications include at least one of:
enterprise applications internal to the EAM system;
enterprise applications external to the EAM system; or
IoT/sensor devices.

4. The system of claim 1, wherein at least one of:
the ToEAM queue and the FromEAM queue are managed AWS SQS BOD queues;
the API further includes a RESTful API; or
the dataflow studio is configured to periodically query the FromEAM queue for records from the EAM system.

5. The system of claim 1, wherein the dataflow studio is configured to allow a user to build and configure a flow by linking processors that receive and process data from the EAM system for use by an enterprise application endpoint and/or receive and process data from the enterprise application endpoint for use by the EAM system, optionally wherein the dataflow studio comprises a drag-and-drop interface to build and configure the flow.

6. The system of claim 1, wherein the dataflow studio comprises:
an integration component;
a transformation component; and
an analysis component.

7. The system of claim 1, wherein the computer processes further comprise:
a 360 transaction view component configured to integrate data events from the dataflow studio into a user-comprehensible flow to provide visibility into data and process flows both within the EAM system and within the dataflow studio, optionally wherein the 360 transaction view component allows a user to troubleshoot a message transaction utilizing an end-to-end view of messages between the EAM system and the dataflow studio.

8. A computer program product comprising at least one tangible, non-transitory computer-readable medium having embodied therein computer program instructions for integrating an enterprise asset management (EAM) system with enterprise applications which, when run on at least one processor, implements computer processes comprising:
a dataflow studio comprising a no-code graphical user interface for building and configuring customized business-specific data and process flows between the EAM system and enterprise applications, wherein the dataflow studio integrates with the EAM system via an API including a ToEAM queue for sending records to the EAM system and a FromEAM queue for receiving records from the EAM system; and
an endpoint catalog comprising a centralized registry of enterprise applications that are available to the dataflow studio as endpoints for creating and managing application connections for data integrations between the EAM system and the enterprise applications.

9. The computer program product of claim 8, wherein creation of a process flow between the dataflow studio and the endpoint catalog comprises:
querying the EAM system by the dataflow studio for tenant specific endpoint connections in the endpoint catalog;
causing display of a dialog box listing the tenant specific endpoint connections on a display device of a user computer;
in response to receiving a user input of a selected tenant specific endpoint connection, mapping, by the dataflow studio, the selected tenant specific endpoint connection to a corresponding processor type, configuring the selected tenant specific endpoint connection using metadata values from the EAM system, and writing a UUID of the processor to the EAM system as endpoint metadata for reference; and
updating endpoint metadata for the endpoint in the EAM system including querying the dataflow studio by the EAM system for a reference to the processor and updating the endpoint metadata based on the reference to the processor.

10. The computer program product of claim 8, wherein the enterprise applications include at least one of:
enterprise applications internal to the EAM system;
enterprise applications external to the EAM system; or
IoT/sensor devices.

11. The computer program product of claim 8, wherein at least one of:
the ToEAM queue and the FromEAM queue are managed AWS SQS BOD queues;
the API further includes a RESTful API; or
the dataflow studio is configured to periodically query the FromEAM queue for records from the EAM system.

12. The computer program product of claim 8, wherein the dataflow studio is configured to allow a user to build and configure a flow by linking processors that receive and process data from the EAM system for use by an enterprise application endpoint and/or receive and process data from the enterprise application endpoint for use by the EAM system, optionally wherein the dataflow studio comprises a drag-and-drop interface to build and configure the flow.

13. The computer program product of claim 8, wherein the dataflow studio comprises:
an integration component;
a transformation component; and
an analysis component.

14. The computer program product of claim 8, wherein the computer processes further comprise:
a 360 transaction view component configured to integrate data events from the dataflow studio into a user-comprehensible flow to provide visibility into data and process flows both within the EAM system and within the dataflow studio, optionally wherein the 360 transaction view component allows a user to troubleshoot a message transaction utilizing an end-to-end view of messages between the EAM system and the dataflow studio.

15. A method for integrating an enterprise asset management (EAM) system with enterprise applications, the method comprising:
providing a dataflow studio comprising a no-code graphical user interface for building and configuring customized business-specific data and process flows between the EAM system and enterprise applications, wherein the dataflow studio integrates with the EAM system via an API including a ToEAM queue for sending records to the EAM system and a FromEAM queue for receiving records from the EAM system; and
providing an endpoint catalog comprising a centralized registry of enterprise applications that are available to the dataflow studio as endpoints for creating and managing application connections for data integrations between the EAM system and the enterprise applications.

16. The method of claim 15, wherein creation of a process flow between the dataflow studio and the endpoint catalog comprises:
querying the EAM system by the dataflow studio for tenant specific endpoint connections in the endpoint catalog;
causing display of a dialog box listing the tenant specific endpoint connections on a display device of a user computer;
in response to receiving a user input of a selected tenant specific endpoint connection, mapping, by the dataflow studio, the selected tenant specific endpoint connection to a corresponding processor type, configuring the selected tenant specific endpoint connection using metadata values from the EAM system, and writing a UUID of the processor to the EAM system as endpoint metadata for reference; and
updating endpoint metadata for the endpoint in the EAM system including querying the dataflow studio by the EAM system for a reference to the processor and updating the endpoint metadata based on the reference to the processor.

17. The method of claim 15, wherein the enterprise applications include at least one of:
enterprise applications internal to the EAM system;
enterprise applications external to the EAM system; or
IoT/sensor devices.

18. The method of claim 15, wherein at least one of:
the ToEAM queue and the FromEAM queue are managed AWS SQS BOD queues;
the API further includes a RESTful API; or
the dataflow studio is configured to periodically query the FromEAM queue for records from the EAM system.

19. The method of claim 15, wherein the dataflow studio is configured to allow a user to build and configure a flow by linking processors that receive and process data from the EAM system for use by an enterprise application endpoint and/or receive and process data from the enterprise application endpoint for use by the EAM system, optionally wherein the dataflow studio comprises a drag-and-drop interface to build and configure the flow.

20. The method of claim 15, wherein the computer processes further comprise:
a 360 transaction view component configured to integrate data events from the dataflow studio into a user-comprehensible flow to provide visibility into data and process flows both within the EAM system and within the dataflow studio, optionally wherein the 360 transaction view component allows a user to troubleshoot a message transaction utilizing an end-to-end view of messages between the EAM system and the dataflow studio.
